(19) United States
(12) Patent Application Publication
(10) Pub. No.: US 2005/0224101 A1
(43) Pub. Date: Oct. 13, 2005

(54) Dishwasher

(76) Inventor: Walter Assmann, Bielefeld (DE)

Correspondence Address: Law Offices of Karl Hormann, 86 Sparks Street, P.O. Box 381516, Cambridge, MA, 02238-1516, US

(21) Appl. No.: 11/100,786

(22) Filed: Apr. 7, 2005

(30) Foreign Application Priority Data
Apr. 7, 2004 (DE) 10 2004 017 612.4

(51) Int. Cl. B08B 3/00

(52) U.S. Cl. 134/60

(57) ABSTRACT

A dishwasher with a double-walled door pivotal between open and closed states and provided between its walls with a salt receiving container provided with a vent opening over part of its upper wall extending between the walls of the door. The vent opening is connected a vent channel at least part of which is narrowed down by a ridge extending partly across the channel and which extends over the salt receiving container and along a lateral wall thereof the a lower section for providing access to ambient air.

### BACKGROUND OF THE INVENTION

1. Field of the Invention

The invention, in general, relates to a dishwasher and, more particularly, to a dishwasher of the kind provided with a dish washing chamber closed by a door and a water softening unit provided with an ion exchanger and a salt container for the preparation of brine, the salt container being disposed in an intermediate chamber adjacent to the door and chargeable through a closable salt fill opening in its front wall adjacent to the inner surface of the door.

2. The Prior Art

A dishwasher of this kind is generally known from German patent specifications DE 102 01 792 C1 and DE 102 04 548 A1.

For the prevention of lime deposits on dishes it is known to soften the water entering the dish washing chamber of a dishwasher by feeding it through an ion exchanger. In household dishwashers, the ion exchanger usually is provided with a mixed bed resin the softening components of which will become exhausted and require replenishment by a salt solution. For receiving a supply of salt sufficient for several regeneration cycles, a water softener is provided with a salt container in addition to the ion exchanger. It is known and generally practiced in commercial dishwashers to arrange the salt container at the bottom or the housing of the apparatus and to charge or fill it through an opening in the bottom panel of the washing chamber. For a user, this is uncomfortable or inconvenient since it compels him to reach deeply into the washing chamber. The disadvantage is greater still when lacking salt is detected while the machine is filled with dishes. In such a case, the lower dish basket must first be unloaded before it can may be removed from the washing to provide free access to the filling opening of the salt container. To avoid these disadvantages, German patent specification DE 102 01 792 C1 and DE 102 04 548 A1 propose to position the salt container within the door of the apparatus for filling it in a simple manner through a salt feed opening at the interior surface of the door. Owing to the narrow space between the inner and outer surface panels of the door the design of such a salt container has to be very thin. Because of the arrangement of the salt fill opening in front wall which is vertically disposed when the door is closed during operation, the salt container cannot be filled completely with salt or fluid. For that reason an air cushion will form above the brine. During operation of the dishwasher the air cushion will expand as a result of a rise in temperature.

German patent specification DE 692 01 234 discloses a brine preparation arrangement integrated into the door of an apparatus which at the output of the regenerating water dispenser allows a temperature-affected medium to escape through a channel leading to the interior of the washing chamber. The output tube of the channels forms a syphon which prevents balancing of the air between the salt container and the environment.

Another problem arises in handling dishwashers where it is necessary for purposes of a repair to change their upright operating disposition and place the machine on its back, one of its side surfaces, or even on its top surface, or where the position of the machine is changed during transport. In such cases it is practically impossible to prevent the brine from escaping from the salt container through the vent opening.

### OBJECT OF THE INVENTION

It is thus an object of the invention to provide for venting of the salt container while preventing the brine from escaping while the apparatus is being moved.

### SUMMARY OF THE INVENTION

In accordance with the invention, the object is accomplished by a dishwasher the salt container of which is provided with a separate vent opening which is located in the wall disposed at the top when the door is closed during operation and by the vent opening leading to a vent channel disposed above the salt container and providing for a connection between the interior of the salt container and the environment.

Further advantageous features, embodiments and designs of the invention will be described hereinafter and will be set forth in the claims.

The advantages derived from the invention are, among others, that the salt container is provided with a separate vent which during operation while the door is closed is disposed above the fluid level of the brine in the salt container. At the formation of increased pressure in the salt container excess air is vented directly without any quantities of brine entering into the wash chamber as a result of their displacement. Another advantage results from the fact that there is no opening directed to the interior of the washing chamber. In this manner, the opening cannot be plugged up by the brine and contaminations contained therein, and the brine is prevented from entering into the salt container.

In an advantageous embodiment the vent opening in the top wall extends from a front wall adjacent to the interior or exterior surface of the door over only a partial section of the width of the top wall. The depth of the opening may be dimensioned such that in a position of the salt container in which the front wall is disposed horizontally and on top, the volume below the opening corresponds at least to the volume formed below the salt fill opening when the door is closed in the operative position. This prevents brine from escaping from the salt container when the dishwasher lies on either its back or front surface (depending upon the disposition of the opening).

It is particularly advantageous to arrange the vent opening in the area of the top wall adjacent to the interior surface of the door. Not only does this prevent brine from escaping when the dishwasher lies on the side of its door, but the door is protected against an escape of brine as well when in its more frequently occurring horizontal open position.

It is also advantageous additionally to use a ridge for narrowing a section of the channel adjacent to the top wall to a gap extending from the front wall opposite the vent opening over a partial section of the depth of the top wall. The height of the ridge has to be dimensioned such that when the salt container assumes a position in which this front wall is disposed horizontally and on top, the volume below the opening corresponds at least to the volume formed below the salt fill opening in the operating position when the door is closed. This prevents the brine from escaping from the salt container when the dishwasher lies on its back surface or on its door surface (or when the door is open).

In an especially advantageous embodiment the vent channel extends at least approximately to the diagonally opposite area of the salt container. In this manner, an escape of the brine is prevented when the dishwasher lies on its side surface or on its top surface (as may be required when its circulating pump needs to be removed). In this embodiment it is of further advantage to extend the vent channel around the salt container along its covering wall and a side wall approximately to its bottom region. This avoids narrowing the salt container and facilitates sliding of the salt to the lower region. In this connection, it is efficient to locate the vent opening at the beginning of the channel.

Furthermore, it is efficient to provide a stub at the end of the vent channel opposite the vent opening. In an advantageous embodiment the bottom of the washing chamber may then be widened to a door channel extending at least in part below the door, and in an operative state the output stub may feed into the door channel when the door is closed. In this manner, any small quantity of brine cannot escape to the outside when the dishwasher is moved from an upside-down disposition by way of the side where the output stub is located to its operating disposition.

It is also advantageous to fabricate the salt container with its vent channel and salt fill opening of plastic. It would provide for integrated airing and venting which can be economically produced.

### DESCRIPTION OF THE SEVERAL DRAWINGS

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

FIG. 1 is a schematic side elevation in section of a dishwasher;

FIG. 2 is a perspective view of a vent channel around the salt container indicated in the door of the apparatus; and

FIG. 3 is a view in detail of the input opening of the channel path.

### DETAILED DESCRIPTION OF THE PREFERRED EMBODIMENT

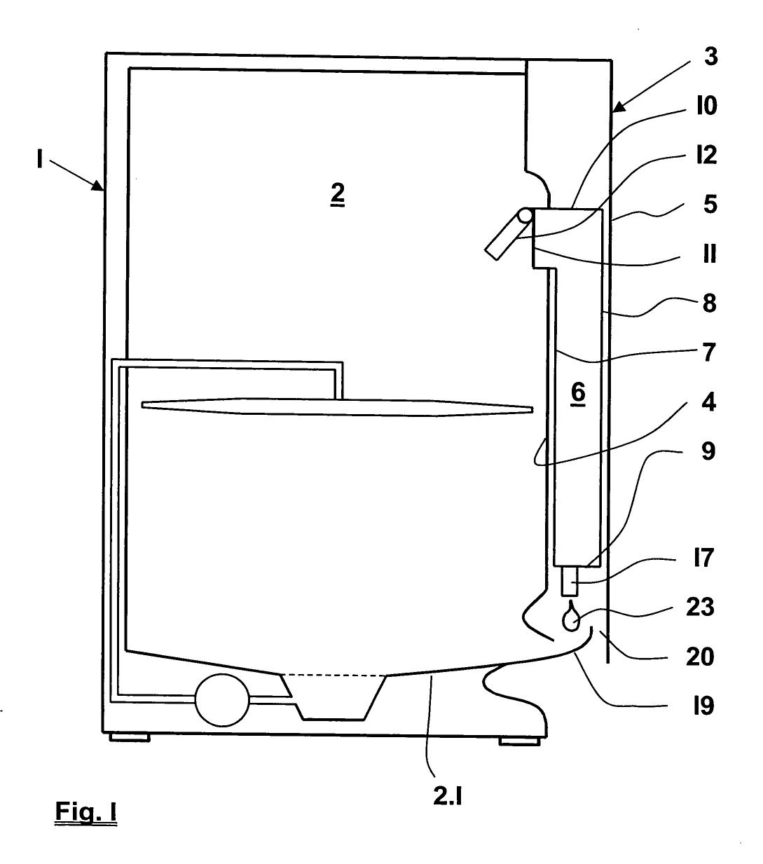

FIG. 1 is a schematic side view of a dishwasher 1 provided with a washing chamber 2 which may be closed by a pivoting door 3. The door 3 is essentially fabricated of two sheet-metal door panels 4 and 5. The outwardly facing panel 5 may be provided with a decorative plate (not shown) matching the decor of other kitchen furniture. Between the door panels 4 and 5 there is provided a salt container 6 for preparing brine for a water softening device (not shown) integrated into the dishwasher. The brine serves to regenerate the softener which may be a mixed bed resin in an ion exchanger (also not shown).

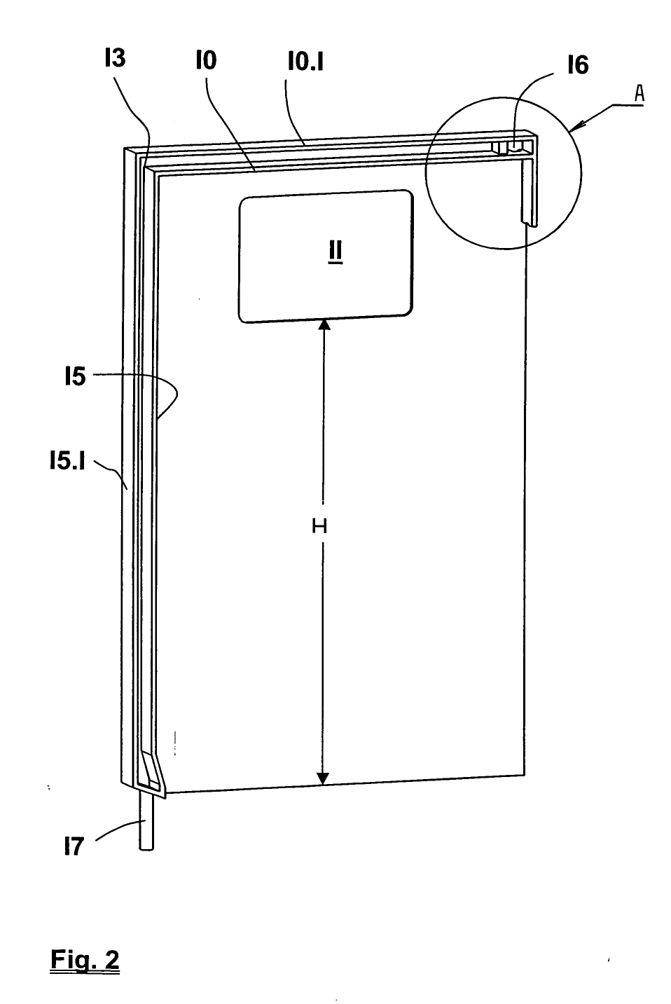

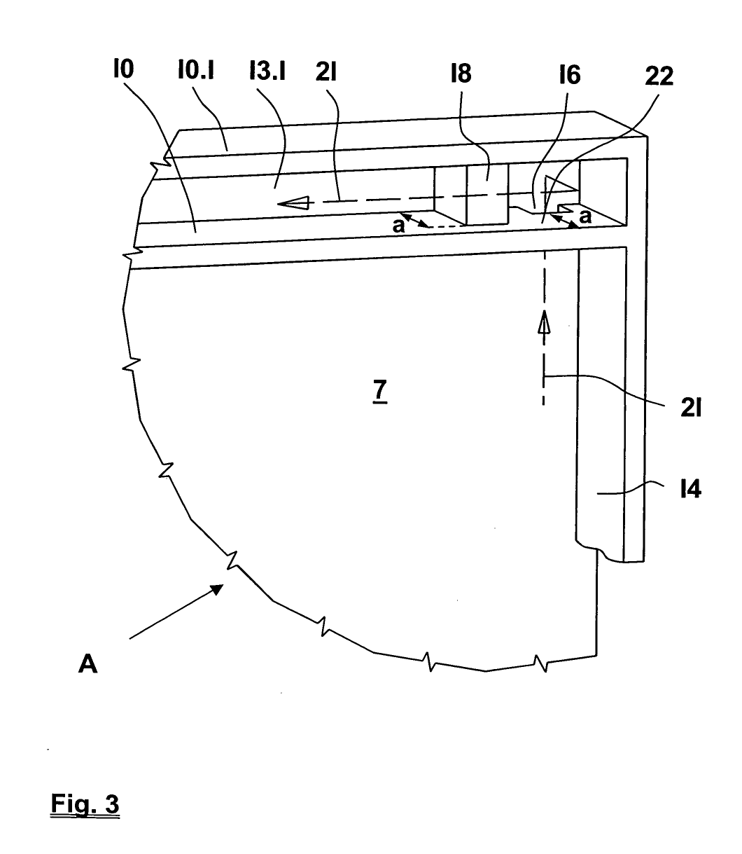

FIG. 2 depicts a salt container of simplified parallelepiped structure. Alternatively, the salt container may be shaped similarly to the one known from German patent specification DE 103 11 126 A1. It is only necessary that the container consist of two front walls 7 and 8 respectively facing the door panels 4 and 5, a bottom wall 9, a narrow top wall 10 and two narrow side walls 14 and 15 (see FIGS. 2 and 3). In its upper section, the front wall 7 facing the internal door panel 4 is provided with a salt fill opening 11 which may be closed by a cover 12 hingedly mounted on the internal door panel 4.

A vent channel 13 extends around the salt container 6 along the entire top wall 10 and along a side wall 15 down to the bottom area. For this purpose, the salt container 6 is in these areas provided with double walls with the space intermediate these two walls 10 and 10.1 and the two walls 15 and 15.1 constituting the channel 13. A vent opening 16 in the top wall 10 provides a permanent connection between the interior of the salt container 6 to the environment or ambient air 20. The outlet to the environment 20 may be seen more clearly in FIG. 1 with a channel stub 17 below the salt container 6 points towards a lower door channel 19. The door channel 19 is in fact constituted by a widened section 2.1 at the bottom of the wash chamber 2 which extends to below the door 3 and allows for a return flow of condensation water or brine, indicated by a drop 23, to the wash chamber 2.

From FIGS. 2 and 3 in particular, the perspective view clearly shows that a labyrinth-like flow path 21 is provided for accommodating brine escaping from the salt container 6 when the door 3 is pivoted or the dishwasher 1 is tilted. The flow path 21 is shown by a dashed line to show the path to be followed by the brine in order to escape. Thus, the vent opening 16 is extending from the front wall 7 over a partial section only of the top wall 10. Therefore, when the salt container 6 assumes a horizontal disposition, for instance, when the door 3 is open, a volume or empty space defined by the bottom surface of the front wall 8 and the width a of the remaining top wall section 22. The volume has to be at least equal to the volume defined by the ground surface of the bottom wall 9 and the height H of the front wall 7 up to the lower margin of the salt fill opening 11 and thus to the maximum holding capacity of the salt container 6. A ridge 18 which narrows the cross-section of the channel section 13.1 to a gap to form the aforesaid labyrinth must also be of width a, provided the two basic surfaces of the front walls 7 and 8 are equal in size. This ensures the amount of brine corresponding to the maximum holding capacity to remain in the salt container 6, even if the dishwasher 1 is placed on its pack surface, and not to flow beyond the ridge 18 into the vent channel 13.

In an improved embodiment of the invention, the salt container 6 mounted between the interior and exterior door panels 4 and 5, is structured as a molded plastic component integral with the vent channel 13 and the salt fill opening 11.

1. A dishwasher, comprising:
a wash chamber;
a door for selectively opening and closing the wash chamber and comprising an interior and an exterior door panel defining an intermediate space therebetween;
a salt receiving container mounted in the intermediate space and comprising a front wall facing the interior door panel and defining a opening for filling salt into the container, the salt receiving container further comprising a top wall disposed is an upper section of the door in its closed state, the top wall defining a vent opening operatively connected to a venting channel extending over the salt receiving container and providing a connection between the interior of the salt receiving container and ambient air.

2. The dishwasher in accordance with claim 1, wherein the vent opening extends in the top wall from one of the interior and exterior door panels over a partial section only of the width of the top wall.

3. The dishwasher in accordance with claim 2, wherein the vent opening is disposed in the area of the top wall adjacent to the interior panel of the door.

4. The dishwasher in accordance with claim 3, wherein a ridge in a section of the channel below the top wall narrows the cross-section of the channel to a gap extending over a partial section only of the width of the top wall from the front wall opposite the vent opening.

5. The dishwasher in accordance with claim 4, wherein the venting channel extends at least approximately to the diagonally opposite area of the salt receiving container.

6. The dishwasher in accordance with claim 5, wherein the venting channel extends around the salt receiving container along the top wall and a lateral wall to at least a bottom portion thereof.

7. The dishwasher in accordance with claim 6, wherein the vent opening is disposed at the beginning of the vent channel.

8. The dishwasher in accordance with claim 7, wherein at its end opposite the vent opening the vent channel is provided with an outlet stud.

9. The dishwasher in accordance with claim 8, wherein the a door channel is formed in the bottom of the wash chamber and extending at least partially below the door and wherein the outlet stud in the closed state of the door enters into the door channel.

10. The dishwasher in accordance with claim 9, wherein the salt receiving container is formed as a molded plastic component integral with a slat inlet opening and the venting channel.
